(19) United States
(12) Patent Application Publication
(10) Pub. No.: US 2008/0201850 A1
(43) Pub. Date: Aug. 28, 2008

(54) Positioning platform for prone breast imaging

(75) Inventors: Jorge A. Brito, Little Rock, AR (US); Michael J. Borrelli, Little Rock, AR (US)

Correspondence Address: Kyla D. Aycock;SPEED LAW FIRM, Suite 1200, 111 Center Street, Little Rock, AR, 72201, US

(73) Assignee: Jorge A. Brito

(21) Appl. No.: 12/072,681

(22) Filed: Feb. 27, 2008

Related U.S. Application Data
(60) Provisional application No. 60/904,083, filed on Feb. 28, 2007.
(60) Provisional application No. 60/920,830, filed on Mar. 29, 2007.

(51) Int. Cl. A61G 7/00

(52) U.S. Cl. 5/601

(57) ABSTRACT

Embodiments include a platform allowing the female breast to be imaged by PET/CT, SPECT, and/or other modalities, while the patient is lying in the prone position. In some embodiments, a cushioned base may support the patient's torso, and articulating head and arm rests may extend from the base. A pair of open-sided lateral openings in the base allows the patient's breasts to hang independently. The articulating head and arm rests may be lockable into a fixed position and may be unlocked and returned to the original locked position. The base may be constructed of a composite material and covered with a cushioning material, with an optional adjustable, pneumatic layer in between. The cushioning material may be form-molded foam or other material. The platform may be attached to an existing PET gantry table via attachment means that allows the platform to be removed and afterward identically repositioned with respect to the gantry table for subsequent imaging.

### CROSS-REFERENCE TO RELATED APPLICATIONS

This application claims benefit of U.S. Provisional Patent Application Ser. No. 60/904,083, filed Feb. 28, 2007 and entitled “Positioning Platform for Prone Breast Imaging,” which is herein incorporated by reference in its entirety. Additionally, this application claims benefit of U.S. Provisional Patent Application Ser. No. 60/920,830, filed Mar. 29, 2007 and entitled “Positioning Platform for Prone Breast Imaging,” which is also herein incorporated by reference in its entirety.

### BACKGROUND OF THE INVENTION

1. Field of the Invention

Embodiments of the present invention generally relate to a positioning platform for supporting a patient in a prone position for breast imaging. One application is for Positron Emission Tomography and Computerized Tomography (PET-CT) imaging.

2. Description of the Related Art

When correlating 3-dimensional anatomical and physiological images such as Magnetic Resonance Imaging (MRI) and/or PET-CT, comparable body positioning is necessary to co-align the images for optimal correlation of the PET-CT and MRI images. This is especially true for imaging the breast. PET-CT imaging of the breasts in the prone position provides much better correlation with MRI for evaluation of breast lesions and improves diagnostic accuracy since MRI images are also acquired with the patient in the prone position.

### SUMMARY OF THE INVENTION

Embodiments permit the female breast to be imaged with PET-CT, MRI, PET/MRI, SPECT/CT and/or any other imagining modality while the patient is lying in the prone position, with the breasts hanging freely and independently.

Embodiments offer the advantages of safety and comfort for the patient, improved alignment of images, ease of set-up and use, and cost decreases.

Embodiments include a positioning platform for prone breast imaging, comprising a cushioned base for supporting the patient's torso, the base having a cephalic end and a caudal end, and a pair of open-sided lateral openings through which the patient's breasts hang independently.

These and other features, objects, and advantages of embodiments will become better understood from a consideration of the following detailed description of the preferred embodiments and appended claims in conjunction with the drawings as described following.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side elevation view of a first embodiment of a platform.

FIG. 2 is a top plan view of the platform of FIG. 1.

FIG. 3 is a side elevation view of a second embodiment of a platform.

FIG. 4 is a top plan view of the platform of FIG. 3.

### DETAILED DESCRIPTION

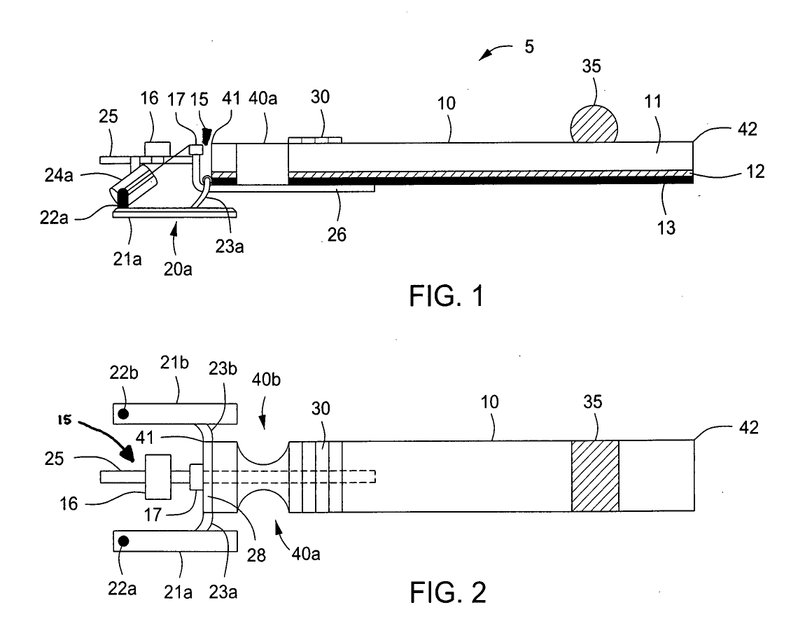

With reference to FIGS. 1-4, exemplary embodiments may be described. A first embodiment depicted in FIGS. 1-2 includes a platform 5 comprising a base 10, which is preferably a cushioned base, for supporting the patient's torso and may include a preferably comfortable articulating head rest 15 and one or more arm rests 20a, 20b, which are also preferably comfortable and articulating, extending from the base 10. The base 10 includes a cephalic end 41 and a caudal end 42. The base 10 further comprises a pair of open-sided lateral openings 40a, 40b through which the patient's breasts hang independently. The lateral openings 40a, 40b for the breasts are located through the platform 5 at or near the cephalic end 41 of the platform, preferably close to the head rest 15, for example as shown in FIGS. 1-2.

A patient's torso and shoulders may rest against the cushioning at or near the cephalic end 41 of the platform 5. In operation, each patient is positioned on the platform 5, and the platform 5 may be adjusted such that the patient's breasts hang freely through the lateral openings of the platform 5. One or more cushioned wedges may be used to support the shoulders to help hold the patient in position and/or to provide comfort.

The head rest 15 for supporting and providing comfort to the head and the arm rests 20a, 20b for supporting and providing comfort to the arms of the patient may be located at or near the cephalic end 41 of the base 10. If the arm rests 20a, 20b are part of the cephalic end 41 of the base 10, they may be located lower than the base 10 for better comfort. The head rest 15 may comprise a separate chin rest or support 17 and forehead rest or support 16 as well, and either or both may be articulating. It is desirable that the articulating head rest 15 and arm rests 20a, 20b be lockable into a fixed position once a patient is maneuvered into a safe and comfortable position that is effective for imaging. The head rest 15 and/or arm rests 20a, 20b may be desirably provided with means to unlock and then return them to the locked position used for the initial imaging so that the head rest 15 and/or arm rests 20a, 20b may be placed into the identical position for any subsequent imaging procedures. One way to accomplish this repositioning is to have fiducial markers or some form of numbering/measuring scale on one or more of the head rest 15 and/or arm rests 20a, 20b (or on each of the rests 15, 20a, and 20b), to indicate their positioning when they are locked, thus permitting re-creation of the same locked positions at a subsequent time. In one embodiment, one or more fiducial markers are included for both MRI and PET/CT detection. In an exemplary embodiment, the platform 5 contains at least six locations wherein contrast agents for both MRI and PET/CT can be placed to serve as fiducial reference points for more accurate fusion of MRI and PET/CT images.

In the first embodiment, the head rest 15 and the arm rests 20a, 20b are articulatable via a first articulating member 25 and second articulating member 26 for articulating the head rest 15 and chin rest 17, a third articulating member 23a for articulating the arm rest 21a, and a fourth articulating member 23b for articulating the arm rest 21b. Although the articulating members may be made of any articulatable material, in one example, one or more of the articulating members include 1-inch diameter articulated tubing. The first articulating member 25 is operatively connected at or near one of its ends to a location at or near a first end of the second articulating member 26. The third and fourth articulating members 23a and 23b are operatively connected at or near their first ends to a location at or near the cephalic end 41 of the base 10. The articulating members 25, 26, 23a, and 23b may be moveable with respect to the base 10 to adjust the platform 5 for comfort of the patient. The articulation of the articulating members 25, 26, 23a, and 23b may be accomplished by supplying drive force to the articulating members by any method and/or device known to those skilled in the art, including but not limited to mechanical and/or electrical force and devices for supplying mechanical and/or electrical force.

The head rest 15 is preferably positioned such that the neckline and head will always be centered along the mid-line axis of the platform 5. This positioning will minimize image distortion and improve the ability to re-align the patient in the same position throughout an imaging series.

In the shown embodiment of FIGS. 1-2, the forehead support 16 is located on the first articulating member 25, and the chin support 17 is disposed on the first end of the second articulating member 26. Although the articulating members are shown as separate members, one or more or all of the articulating members may be formed integrally with one another and constitute the same member. The arm rest 21a may include a hand grasp member 22a operably connected thereto, and the arm rest 21b may include a hand grasp member 22b operably connected thereto. The hand grasp members 22a and 22b allow the patient to grasp these hand grasp members 22a and 22b while lying down on the platform 5, while the arm rests 21a and 21b permit the patient to rest his or her forearms and at least a portion of his or her arms on a support or platform while lying down on the platform 5. Optionally, one or more water (or other liquid) containers 24a and 24b (e.g., bottles) may be provided on the arm rests 21a and 21b (with optional drinking straws or other members to extend the reach of the liquid to the user) to provide water to the patient while he or she is lying down on the platform 5.

In one example of an embodiment, the openings 40a and 40b in the base 10 for the breasts may be approximately six inches to approximately 8 inches in diameter and cylindrical. It is understood, however, that any shape and diameter or other dimensions of the openings 40a and 40b are contemplated as part of embodiments of the present invention, and these dimensions and shapes are not limiting to the scope of the invention.

The base 10 may be constructed of one or more composite materials, preferably one or more thin composite materials, for structural strength and covered with one or more cushioning materials. The base 10 and one or more composite materials may be constructed from any material capable of providing structural strength known to those skilled in the art, and the one or more cushioning materials may be constructed from any material capable of cushioning a body of a patient which is known to those skilled in the art.

In some embodiments, the platform 5 includes segmented pneumatic or hydraulic cushions thereon. The cushioning on the base 10 of the platform 5 may be formed so that its vertical dimension and rigidity (hardness) can be adjusted using one or more pneumatic and/or hydraulic mechanisms. The cushioning may be segmented so that different regions of the cushioning along the length of the platform 5 may be adjusted independently to maximize patient comfort. This arrangement permits adjusting the platform cushioning to accommodate patients with back problems, large midsections, injuries, etc. in a manner that minimizes their ability to move yet restricts their movement such that they are comfortable.

In one embodiment, the base 10 includes a lower layer 13, an optional middle layer 12, and an upper layer 11. The lower layer 13 may be a lower support layer and may be constructed of the one or more composite materials to provide structural strength. The upper layer 11 may be a cushioning layer and may be constructed of one or more cushioning materials. The one or more cushioning materials may be, for example, form-molded or form-fitting foam (or any other type of foam) or may be pneumatic. The middle layer 12 may include one or more pneumatic and/or hydraulic layers sandwiched between the upper layer 11 and lower layer 13. This layer will permit adjusting the platform height to ensure that a patient's breasts hang freely (see FIG. 1). A pneumatically-adjusted support (via the middle layer 12 and/or upper layer 11) allows the patient to be positioned in the platform 5 for maximum comfort and permits optimal placement and imaging the breasts. In some embodiments, it is desirable that the composite structural material and the overlying cushioning material be as thin as possible.

Optionally, one or more supports 30 may be located on an upper surface of the base 10 (e.g., on its upper layer 11) to provide support and comfort to the hips and/or belly of the patient. Also optionally, one or more ankle supports 35 may be located on the upper surface of the base 10 (e.g., on its upper layer 11) to provide support and comfort to the ankles of the patient. The one or more ankle supports 35 allow the feet to be kept at a more natural and comfortable angle relative to the tibia (an angle of preferably approximately 90 degrees) instead of a larger, hyper-extended angle which is uncomfortable for many patients. The supports 30 and/or 35 may be moveable along the base 10 so that they are adjustable to fit the patient's body. The ankle support 35 and/or support 30 may be moveable forwards and backwards relative to the cephalic end 41 of the base 10 over a length of approximately 1 foot or more.

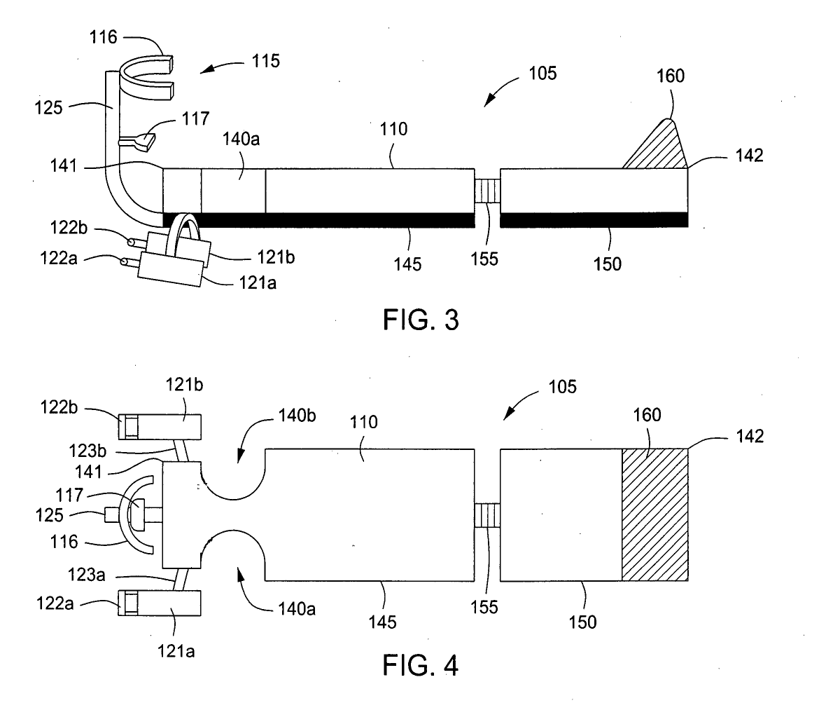

A second embodiment is shown in FIGS. 3-4. In this embodiment, like components to the components of the first embodiment shown in FIGS. 1-2 are denoted by the same numbers as in FIGS. 1-2 but in the “100” series. For example, the platform 105, base 110, arm rests 121a-b, hand grasps 122a-b, head rest 115, forehead support 116, chin support 117, lateral openings 140a-b, and first articulating member 125 are designated by the same numbers as designate these components in the first embodiment but with numbers in the “100” series.

The base 110 of FIGS. 3-4 includes a posterior portion 150 and an anterior portion 145 operably connected by a telescoping and articulating hinge 155 to allow adjustment of the two portions 145 and 150 laterally and/or vertically with respect to one another. The articulating hinge 155 may also be adjustable in length to accommodate patients of different heights. In this embodiment, the lateral openings 140a-b for the breasts are located within the anterior portion 145 of the platform 105 near the head rest 115. A patient's torso and shoulders may rest against the cushioning of the anterior portion 145 of the platform 105. Each patient may be positioned on the platform 105, and the platform 105 may be adjusted so that the patient's breasts hang freely through the lateral openings 140a-b of the platform 105.

One or more cushioned wedges may be used to support the shoulders to help hold the patient in position and/or provide comfort. The anterior portion 145 may include the head rest 115 and/or arm rests 121a-b, but the arm rests 121a-b are preferably disposed lower than the base 110 for better comfort. In addition to the arm rests 121a-b and head rest 115, the base 110 may include one or more leg rests 160 thereon and extendable therefrom which are lockable into a fixed position and may be unlocked and returned to the original locked position.

Any or all elements and features of the embodiments of FIGS. 1-2 may be included with the embodiments of FIGS. 3-4, and vice versa.

Since PET-CT imaging requires a long duration of time (for example, a longer time duration than the time for an MRI alone), it is important that the patient be as comfortable as possible during the procedure. If the patient is not comfortable, the patient is likely to move in an attempt to relieve any discomfort and such motion will produce a less than optimal image, perhaps necessitating repeating the scan. The articulations of embodiments provide one solution to the problem of dealing with the duration of time involved in a PET-CT imaging procedure. Additionally, sensory distraction may optionally be added to the invention in the form of audio or video presentations to assist the patient in not focusing on the discomfort of the situation.

The platform 5 or 105 may be operably attached to an existing PET gantry table. It is desirable that the platform 5 or 105 and gantry table be provided with attachment means so that the position of the platform 5 or 105 may remain identical in subsequent procedures and so that the platform 5 or 105 may be removed and identically repositioned with respect to the gantry table for subsequent procedures. Any attachment means or attachment members known to those skilled in the art may be utilized to attach the platform 5 or 105 to the PET gantry table. The platform 5 or 105 may also be provided with one or more fiducial markers to assist in locating the platform 5 or 105 and the patient in identical positions.

In the case of lesions close to the chest wall, embodiments improve image resolution and provide superior evaluation of breast lesions because gravity forces the breast tissue away from the chest wall when the patient is imaged in the prone position.

A further advantage of embodiments is that having the patient in a prone position will result in better imaging of the lymphatic system in the axillary regions for cancers other than breast cancer.

In addition, the platform 5 or 105 of the present invention may be used in Nuclear Cardiology for Single Photon Emission Computed Tomography (SPECT) myocardial imaging. When doing SPECT imaging of females, the breast tissue may create an artifact in the image of the walls of the heart due to the intervening breasts. The attenuation correction of SPECT cameras is inadequate and breast artifact is a common problem, particularly in large-breasted women. The breast artifact may show as a fixed defect or as a reversible defect. A fixed defect is an artifact that is present in the images obtained under both rest and stress conditions. A reversible defect is a defect that is present in stress images and not present or improved in rest images. This is of concern because reversible defects are indicative of a myocardium at risk for future cardiac events. Patients with false positive results due to reversible breast artifact may have unnecessary coronary angiograms. Prone breast images may resolve this problem.

Embodiments are directed primarily to PET-CT imaging. However, the platform of the present invention may also be used with MRI-PET provided that the platform is made of non-magnetic materials. For use with MRI-PET, it is particularly important that the articulations be made of non-magnetic materials having sufficient strength to safely support the patient, such as aluminum, surgical steel, carbon fiber composites and the like. Furthermore, embodiments may be used with any other imaging modalities known to those skilled in the art.

Advantageously, embodiments allow the articulating rests described above to be positioned easily and reproducibly and then locked into position for the imaging process, thereby providing maximal patient comfort while permitting the physician to obtain a series of images in which the patient is located in a nearly identical position or identical position for each image. This nearly identical or identical positioning permits better comparisons of regions of interest throughout the imaging series. In particular, the articulating arm rests will also provide the best means of comfortably locating the patient's arms forward of the breasts in order to obtain improved imaging of the axilla. Generally, the articulating head, arm, and leg rests permit accurate repositioning and subsequent imaging, better image quality, and improved imaging of the axilla.

In the above embodiments, the core of the platform base 10 or 110 may be constructed of lightweight but strong composite material and may be located and locked into position at specific sites on the PET/CT table. Using light, composite materials will provide strength and rigidity to the platform 5 or 105 while making it lighter and easier to carry, maneuver, and manipulate. The platform 5 or 105 may include adjustable locking devices to attach the platform 5 or 105 to the PET/CT table, and which will permit users to accurately locate the platform 5 or 105 in the same position on the PET/CT table throughout a series of imaging procedures. This will permit accurate repositioning of the patient for better registration, fusion, and comparison of images taken throughout the imaging series.

The attachment system is preferably flexible enough so that the platform 5 or 105 may be attached to the different PET/CT tables found on PET/CT instruments from different manufacturers. There may even be a pneumatic bladder on the underside of the platform 5 or 105 that can be adjusted to conform to the different curvatures found on PET/CT tables from different manufacturers. Furthermore, the platform 5 or 105 may be such that it can also be attached to and used with SPECT/CT instruments.

Embodiments have been described with reference to certain preferred and alternative embodiments that are intended to be exemplary only and not limiting to the full scope of the present invention. While the foregoing is directed to embodiments of the present invention, other and further embodiments of the invention may be devised without departing from the basic scope thereof, and the scope thereof is determined by the claims that follow.

1. A positioning platform for prone breast imaging, comprising:
a cushioned base for supporting the patient's torso, the base having a cephalic end and a caudal end; and
a pair of open-sided lateral openings through which the patient's breasts hang independently.

2. The platform of claim 1, further comprising at least one articulating head rest at or near the cephalic end.

3. The platform of claim 2, wherein the at least one head rest comprises at least one chin rest.

4. The platform of claim 1, further comprising at least one articulating arm rest at or near the cephalic end.

5. The platform of claim 4, wherein the at least one articulating arm rest is disposed lower than the base.

6. The platform of claim 1, further comprising at least one ankle support at or near the caudal end.

7. The platform of claim 2, wherein the at least one articulating head rest is releasable and lockable into a fixed position.

8. The platform of claim 2, wherein the at least one articulating head rest comprises means to unlock and return the at least one articulating head rest to the original locked position so that a patient may be placed into an identical position for subsequent procedures.

9. The platform of claim 1, wherein the base comprises a thin composite material covered with a cushioning material.

10. The platform of 9, wherein the cushioning material comprises form-molded foam.

11. The platform of claim 9, wherein the cushioning material comprises a pneumatically-adjusted support.

12. The platform of claim 1, further comprising sensory distraction means.

13. The platform of claim 1, further comprising means for attaching to a PET gantry table.

14. The platform of claim 13, wherein the means for attaching comprises means associated with the platform and means associated with the gantry table for removing the platform from the gantry table and identically repositioning the platform with respect to the gantry table for subsequent procedures.

15. The platform of claim 1, further comprising one or more fiducial markers to assist in locating the platform and the patient in identical positions.

16. The platform of claim 1, wherein the platform comprises non-magnetic material.

17. The platform of claim 16, wherein the non-magnetic material is selected from the group consisting of aluminum, surgical steel, carbon fiber composites, and a combination thereof.

18. The platform of claim 1, wherein the base further comprises:
a posterior portion and an anterior portion, and
an articulating hinge disposed between the anterior portion and the posterior portion.

19. The platform of claim 18, wherein the pair of lateral openings are disposed to either side of the articulating hinge in the anterior portion of the base.

20. The platform of claim 18, wherein the articulating hinge comprises means for longitudinal length adjustment of the base.

21. The platform of claim 3, wherein the at least one articulating chin rest is releasable and lockable into a fixed position.

22. The platform of claim 4, wherein the at least one articulating arm rest is releasable and lockable into a fixed position.

23. The platform of claim 3, wherein the at least one articulating chin rest comprises means to unlock and return the at least one articulating chin rest to the original locked position so that a patient may be placed into an identical position for subsequent procedures.

24. The platform of claim 4, wherein the at least one articulating arm rest comprises means to unlock and return the at least one articulating arm rest to the original locked position so that a patient may be placed into an identical position for subsequent procedures.
